(19) United States
(12) Patent Application Publication
(10) Pub. No.: US 2024/0206482 A1
(43) Pub. Date: Jun. 27, 2024

(54) Handheld Meat Tenderizing Device

(71) Applicant: Richard Goodhue, Watervile, ME (US)

(72) Inventor: Richard Goodhue, Watervile, ME (US)

(21) Appl. No.: 18/365,269

(22) Filed: Aug. 4, 2023

Related U.S. Application Data
(60) Provisional application No. 63/434,124, filed on Dec. 21, 2022.

(51) Int. Cl. A22C 9/00

(52) U.S. Cl. CPC A22C 9/008

(57) ABSTRACT

A handheld meat tenderizing device is provided. The device is comprised of a first arm and second arm, each with a disc with at least one tenderizing structure extending from each disc. The two arms pivot around a pivot point allowing them to function like a pair of scissors. More specifically, at least one piece of meat can be placed between the disc such that a user can open and close the device to tenderize the meat and prepare it for seasoning and cooking via repeated impacts of the tenderizing structures on the meat.

### CROSS-REFERENCE TO RELATED APPLICATION

The present application claims priority to, and the benefit of, U.S. Provisional Application No. 63/434,124, which was filed on Dec. 21, 2022, and is incorporated herein by reference in its entirety.

### FIELD OF THE INVENTION

The present invention relates generally to the field of meat tenderizing devices. More specifically, the present invention relates to a handheld meat tenderizer device comprised of two arms, each with a disc on one end and needle-like points protruding from the discs. The arms are joined at a pivot point that allows the device to act like a pair of scissors to tenderize and puncture meat as the user squeezes the handles. Accordingly, the present disclosure makes specific reference thereto. Nonetheless, it is to be appreciated that aspects of the present invention are also equally applicable to other like applications, devices, and methods of manufacture.

### BACKGROUND

When tenderizing meat, significant dexterity and coordination are required to strike the meat. However, the repeated action of striking meat while tenderizing said meat can cause significant strain on the user's muscles and may also damage the tenderizing device. Additionally, striking the meat requires a force that can damage the cooking space and surrounding equipment if a user miss the meat with the tenderizing tool. Traditional meat tenderizers also lack the ability to feel the firmness of the meat during tenderizing, leading to non-uniform tenderization throughout the meat. The non-uniform nature of the tenderized meat leads to further time spent tenderizing later in the cooking process, which is inefficient and undesirable.

Therefore, there exists a long-felt need in the art for a device that mitigates the need to strike meat excessively during the tenderizing process. More specifically, there exists a long-felt need in the art for a handheld meat tenderizing device that can be used in home and professional kitchens to ease the tenderization process. Furthermore, there exists a long-felt need in the art for a handheld meat tenderizer device that can be utilized in the home and professional kitchen to ease tenderization that allows spice and seasoning to penetrate the meat at a greater depth to improve the cooking process efficiency.

The subject matter disclosed and claimed herein, in one embodiment thereof, comprises a handheld meat tenderizing device. The device is comprised of two scissor-like handles that move to open and close the working end of the tool. The working end includes several tenderizing structures attached to circular heads that compress the meat between the two heads during use. The tenderizing structures are preferably in the form of needle-like tips that serve to puncture the meat to allow seasoning and spices to penetrate the meat to enhance flavoring. Additionally, the repetitive squeezing tenderizes the meat to aid the cooking process.

In this manner, the handheld meat tenderizing device of the present invention accomplishes all the foregoing objectives and provides a device that eliminates excessive labor and deftness needed to tenderize meat. More specifically, the handheld meat tenderizer device eases the tenderization and seasoning technique allowing a productive alternative to traditional tenderizers. Furthermore, the device can be used in home and professional kitchens to improve the cooking process.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a handheld meat tenderizing device comprised of a first arm and a second arm joined at a pivot point allowing the user to open and close the two arms to tenderize meat. Each arm contains a handle end that allows the user to grip the device to squeeze. More specifically, the handle preferably has a grip that prevents friction, such as a rubber grip or etching on the handle.

Each arm attaches to a disc-shaped object on the opposite end of the handle. The disc end can be in various shapes to accommodate different types of meat. The disc can be attached permanently or through a detachable fastener. The fastener can be from a magnet, a hook and loop fastener, an adhesive fastener, or any other fastener in the art.

More specifically, the disc has at least one needle-like point of rubber, plastic, metal, wood, etc., material for puncturing the meat and tenderizing it. Each arm contains all disclosed features, and the two arms are joined to function as a handheld meat tenderizer device.

During use, the openings of each handle are grasped by the user so that the first arm and second arm function as a lever around the pivot point. Then, the meat is placed in between each disc and needle-like points. As a result, the discs are able to squeeze and puncture the meat to tenderize it and prepare it for seasoning.

The present invention is also comprised of a method of using the device. First, a device is provided comprised of a first arm and a second arm which are attached at a pivot point. Then, the user holds the device by placing their hand through the openings and grasping the handles. Then, the user places the meat between the tenderizing structures. Next, the user squeezes and releases the grips until the meat is tenderized and ready for seasoning.

Accordingly, the handheld meat tenderizing device of the present invention is particularly advantageous as it provides ease of tenderization without the need to swing a conventional tenderizer and risk injury, fatigue, and/or damage to other equipment. More specifically, the handheld meat tenderizing device removes the need for dexterity and the extended time typically required for tenderizing meat. The user can tenderize meat precisely with finer movements of the handheld meat tenderizing device. Furthermore, the handheld meat tenderizing device can be universally applied to all kitchens, both home and professional. In this manner, the handheld meat tenderizing device overcomes the limitations of existing meat tenderizers known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a handheld meat tenderizing device of the present invention while open in accordance with the disclosed architecture;

FIG. 2 illustrates a perspective view of one potential embodiment of a handheld meat tenderizing device of the present invention while closed around a piece of meat in accordance with the disclosed architecture; and

FIG. 3 illustrates a flowchart of a method of using one potential embodiment of a handheld meat tenderizing device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that eliminates the need to repeatedly strike meat to tenderize it. More specifically, there exists a long-felt need in the art for a handheld meat tenderizer device that can be used in the home and professional kitchen to expedite the tenderization process. Furthermore, there exists a long-felt need in the art for a handheld meat tenderizer that can be utilized in the home and professional kitchen to facilitate meat tenderization and allows the penetration of spices and seasonings to enhance the cooking of the meat and reduce user error and fatigue.

The subject matter disclosed and claimed herein, in one embodiment thereof, comprises a handheld meat tenderizing device. The device is designed to act similarly to a pair of scissors in handling, with a first arm and second arm rotating around a pivot point. The first and second arms close on one end to compress a piece of meat between discs attached to each arm to tenderize the meat via at least one tenderizing structure on each disc. The handle where the user squeezes is designed to provide optimal grip through the use of a rubber grip, etched grip, or another means of contouring to the user's hand known in the art.

The first and second arms each attach to a disc on the side opposite of where the user grips each handle the device. The disc is not confined to a disc shape and can be any shape that optimally tenderizes the meat. The disc can also be permanently attached or may be detachable for cleaning purposes and to change out discs for various types of meat.

In one embodiment, each disc is attached to each arm via at least one fastener. The fastener can be a magnet, a hook and loop fastener, an adhesive fastener, or any other fastener in the art. The disc has at least one tenderizing structure made from rubber, plastic, metal, wood, or other material which allows the device to puncture and tenderize meat.

The openings of each handle are grasped by the user so that the first arm and second arm act as a lever around the pivot point during use. Next, the meat is positioned between the tenderizing structures opposite of the handle. Then, the user is able to squeeze the handles to tenderize the meat via repeated puncturing of the meat by the tenderizing structures of each disc.

The present invention is also comprised of a method of using the device. Initially, a device is provided comprised of a first and second arm fastened at a pivot point, wherein each arm is comprised of a disc with at least one tenderizing structure. Next, the user holds the device on the handles and grips. Then, the user places the meat between the tenderizing structures. Finally, the user squeezes and releases the handles until the meat is sufficiently tenderized by the repeated puncturing of the meat by the tenderizing structures.

Accordingly, the handheld meat tenderizing device of the present invention is particularly advantageous as it provides the user with optimal tenderizing capability without the fatigue and potential harmful motion of swinging a traditional tenderizer. More specifically, the handheld meat tenderizer allows for meat tenderizing without the need for the dexterity or coordination of swinging a tenderizing mallet. The device allows the user to tenderize meat precisely with fine movements of the handheld meat tenderizing device. Moreover, the device is capable to be standardized in all kitchens regardless of home or professional use. In this manner, the handheld meat tenderizing device overcomes the limitations of existing meat tenderizers known in the art.

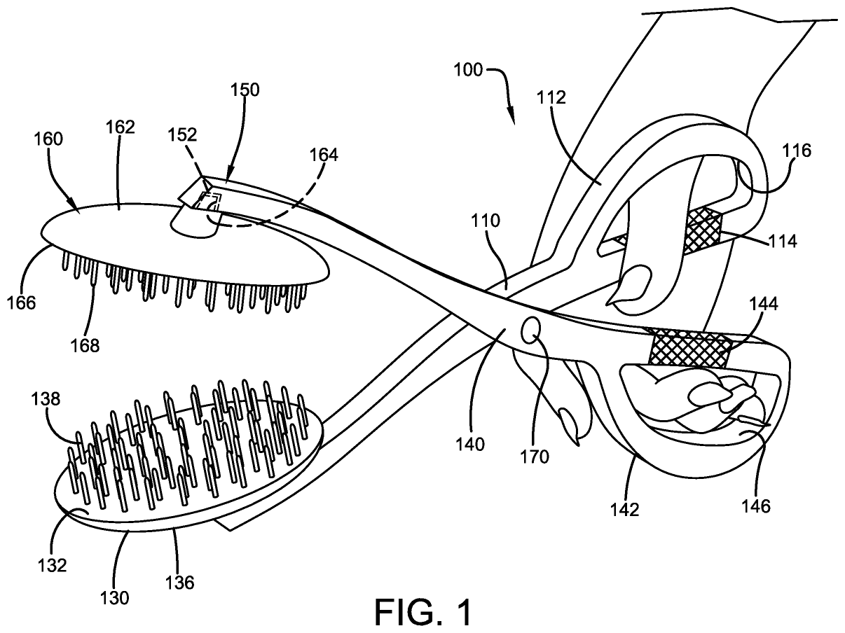

Referring initially to the drawings, FIG. 1 illustrates a perspective view of a first arm 110 and second arm 140 of one potential embodiment of a handheld meat tenderizer device 100 of the present invention in accordance with the disclosed architecture. The first arm 110 is attached to the second arm 140 by at least one pivot point 170. The pivot point 170 may be a hinge, screw, or any other pivot point or structure known in the art that allows the user to open and close the first arm 110 and second arm 140 to tenderize meat with the device 100.

The first arm 110 is comprised of a handle 112 for handling the device 100. The handle 112 is comprised of a grip 114 that can be made of a non-slip rubber material or be an etching on the material for enhanced grip. The handle 112 has at least one opening 116 which the user can place their fingers through to hold the first arm 110. The opening 116 can be various shapes, sizes, or designs that allow for optimal handling and performance of device 100. The first arm 110 is attached to the bottom surface 136 of the disc 130.

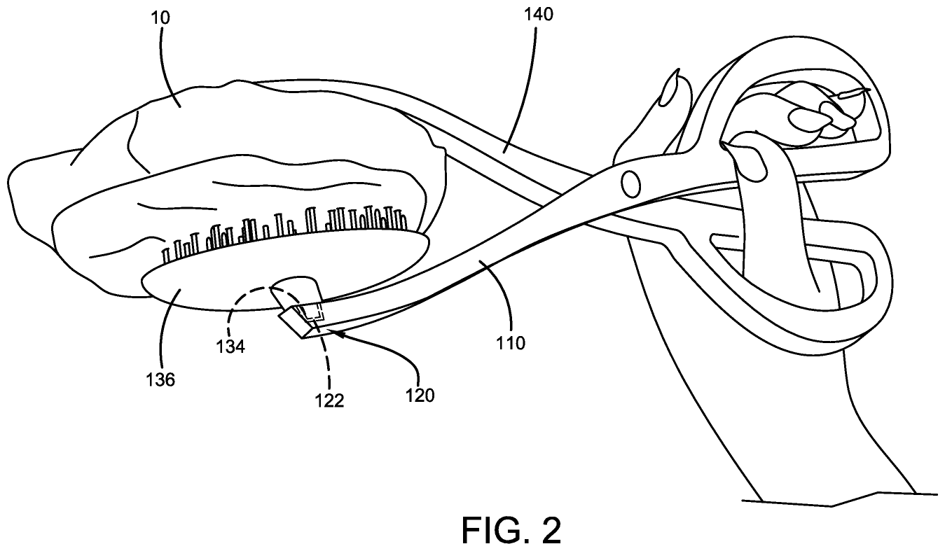

More specifically, the disc 130 may removably attach to the first arm 110 via at least one fastener 134 which attaches to at least one reciprocating fastener 122 positioned on the attachment point 120 on the arm 110, best seen in FIG. 2. The fasteners 134,122 could be any reciprocating fastener type known in the art such as, but not limited to, tongue and groove, male and female, magnet, hook and loop fastener, adhesive fastener, or any other fastener in the art. The fastener 122 attaches and detaches from the attachment point 120 for washing purposes. In another embodiment, the disc 130 is fixedly attached to the arm 110.

The top surface 132 of the disc 130 is comprised of at least one tenderizing structure 138. The top surface 132 can be different shapes or sizes to accommodate various cuts and types of meat. The tenderizing structures 138 are preferably pointed to puncture and tenderize the meat 10. The tenderizing structure 138 can be made of metal, wood, or plastic in different embodiments and may be arranged in any design or pattern on the top surface 132.

The second arm 140 is comprised of a handle 142 for handling the device 100. The handle 142 is comprised of a grip 144 that can be made of a non-slip rubber material or be an etching on the material for enhanced grip. The handle 142 has at least one opening 146 which the user can place their fingers through to hold the second arm 140. The opening 146 can be various shapes, sizes, or designs that allow for optimal handling and performance of device 100. The second arm 140 is attached to the top surface 162 of the disc 160.

More specifically, the disc 160 may removably attach to the second arm 140 via at least one fastener 164 which attaches to at least one reciprocating fastener 152 positioned on the attachment point 150 on the arm 140, best seen in FIG. 1. The fastener 152,164 could be any fastener type known in the art such as, but not limited to, tongue and groove, male and female, magnet, hook and loop fastener, adhesive fastener, or any other fastener in the art. The fastener 164 attaches and detaches from the attachment point 152 for washing purposes. In another embodiment, the disc 160 is fixedly attached to the arm 110.

The bottom surface 166 of the disc 160 is comprised of at least one tenderizing structure 168. The bottom surface 166 can be different shapes or sizes to accommodate various cuts and types of meat. The tenderizing structures 168 are preferably pointed to puncture and tenderize the meat 10. The tenderizing structure 168 can be made of metal, wood, or plastic in different embodiments and may be arranged in any design or pattern on the bottom surface 166.

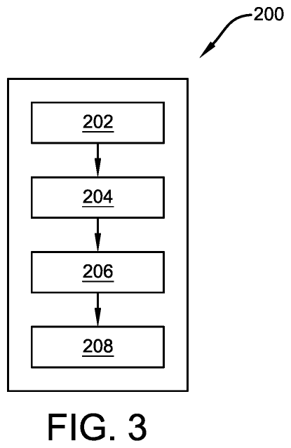

The present invention is also comprised of a method of using 200 the device 100, as seen in FIG. 3. First, a device 100 is provided comprised of a first arm 110 comprised of a disc 130 with at least one tenderizing structure 138, a second arm 140 comprised of a disc 160 with at least one tenderizing structure 168, and wherein the arms 110,140 are attached at a pivot point 170 [Step 202]. Then, the user holds the device 100 by placing their hand through openings 116,146 of the arms 110,140 and grasping each handle 112,142 of the arms 110,140 [Step 204]. Then, the user places at least one piece of meat 10 in between the discs 130,160 of each arm 110,140 [Step 206]. Next, the user repeatedly squeezes and releases the grips 114,144 until the meat 10 is tenderized (i.e., by creating holes in the meat 10) by the tenderizing structures 138,168 of each disc 130,160 and ready for seasoning. The seasoning can then fall into the tenderizing holes created by the device 100 for a more thorough seasoning [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “handheld meat tenderizing device” and “device” are interchangeable and refer to the handheld meat tenderizing device 100 of the present invention.

Notwithstanding the foregoing, the handheld meat tenderizing device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the handheld meat tenderizing device 100 as shown in the FIGS. are for illustrative purposes only, and that many other sizes and shapes of the handheld meat tenderizing device 100 are well within the scope of the present disclosure. Although the dimensions of the handheld meat tenderizing device 100 are important design parameters for user convenience, the handheld meat tenderizing device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A handheld meat tenderizing device comprising:
a first arm comprised of a first opening;
a second arm comprised of a second opening, the second arm attached to the first arm via a pivot point;
a first disc attached to the first arm, the first disc comprised of a first tenderizing structure on a top surface of the first disc; and
a second disc attached to the second arm, the second disc comprised of a second tenderizing structure on a bottom surface of the second disc.

2. The handheld meat tenderizing device of claim 1, wherein the first arm is comprised of a first grip.

3. The handheld meat tenderizing device of claim 2, wherein the first grip is comprised of a non-slip rubber material.

4. The handheld meat tenderizing device of claim 1, wherein the second arm is comprised of a second grip.

5. The handheld meat tenderizing device of claim 4, wherein the second grip is comprised of a non-slip rubber material.

6. The handheld meat tenderizing device of claim 1, wherein the pivot point is comprised of a hinge or a screw.

7. The handheld meat tenderizing device of claim 1, wherein the first tenderizing structure is comprised of a point.

8. The handheld meat tenderizing device of claim 1, wherein the second tenderizing structure is comprised of a point.

9. A handheld meat tenderizing device comprising:
a first arm comprised of a first opening;
a second arm comprised of a second opening, the second arm attached to the first arm via a pivot point;
a first disc comprised of a first fastener attached to a second fastener of the first arm, the first disc comprised of a first tenderizing structure on a top surface of the first disc;
a second disc comprised of a third fastener attached to a fourth fastener of the second arm; and
a second tenderizing structure positioned on a bottom surface of the second disc.

10. The handheld meat tenderizing device of claim 8, wherein the first disc removably attaches to the first arm.

11. The handheld meat tenderizing device of claim 8, wherein the second disc removably attaches to the second arm.

12. The handheld meat tenderizing device of claim 8, wherein the first fastener and the second fastener are comprised of reciprocating fasteners.

13. The handheld meat tenderizing device of claim 12, wherein the first fastener and the second fastener are comprised of a tongue and groove fastener, a male and female fastener, a magnet, an adhesive fastener, or a hook and loop fastener.

14. The handheld meat tenderizing device of claim 8, wherein the third fastener and the fourth fastener are comprised of reciprocating fasteners.

15. The handheld meat tenderizing device of claim 14, wherein the third fastener and the fourth fastener are comprised of a tongue and groove fastener, a male and female fastener, a magnet, an adhesive fastener, or a hook and loop fastener.

16. The handheld meat tenderizing device of claim 8, wherein the first tenderizing structure is comprised of a point.

17. The handheld meat tenderizing device of claim 8, wherein the second tenderizing structure is comprised of a point.

18. A method of using a handheld meat tenderizing device, the method comprising the following steps:
providing a handheld meat tenderizing device comprised of a first arm comprised of a first disc comprised of a first tenderizing structure, a second arm comprised of a second disc comprised of a second tenderizing structure, and wherein the first arm and the second arm are attached at pivot point;
holding the device via a first opening of the first arm and a second opening of the second arm;
placing a piece of meat between the first disc and the second disc; and
squeezing and releasing the first arm and the second arm to tenderizing the piece of meat using the first tenderizing structure and the second tenderizing structure.

19. The method of claim 18, wherein the first tenderizing structure and the second tenderizing structure are comprised of a point.

20. The method of claim 18, wherein the first disc removably attaches to the first arm and the second disc removably attaches to the second arm.
